(19) United States
(12) Patent Application Publication
(10) Pub. No.: US 2026/0171597 A1
(43) Pub. Date: Jun. 18, 2026

(54) BATTERY MODULE COVER AND BATTERY MODULE INCLUDING THE SAME

(71) Applicant: SAMSUNG SDI CO., LTD., Yongin-si (KR)

(72) Inventor: JUNYOUNG LEE, Yongin-si (KR)

(21) Appl. No.: 19/252,885

(22) Filed: Jun. 27, 2025

(30) Foreign Application Priority Data
Dec. 13, 2024 (KR) 10-2024-0186440

(51) Int. Cl. H01M 50/367; H01M 10/647; H01M 10/658; H01M 50/209; H01M 50/276; H01M 50/30; H01M 50/507

(52) U.S. Cl. CPC H01M 50/367; H01M 10/647; H01M 10/658; H01M 50/209; H01M 50/276; H01M 50/394; H01M 50/507

(57) ABSTRACT

A battery module cover and a battery module are disclosed. A battery module cover includes a cover body covering a plurality of battery cells accommodated in a battery module and including a plurality of venting portions exposing each battery vent of each of the plurality of battery cells and a blocking portion formed protrusively from each of the venting portions toward a corresponding battery vent of the battery vents.

### CROSS-REFERENCE TO RELATED APPLICATION

The present application claims priority to and the benefit of Korean Patent Application No. 10-2024-0186440, filed on Dec. 13, 2024 in the Korean Intellectual Property Office, the entire disclosure of which is incorporated herein by reference.

### BACKGROUND

### 1. Field

Aspects of embodiments of the present disclosure relate to a battery module cover and a battery module including the same.

### 2. Description of the Related Art

Secondary batteries may be charged and discharged, unlike primary batteries that may not be recharged. Secondary batteries are widely used in not only portable devices, but also electric or hybrid vehicles driven by electrical power sources, power storage devices, etc.

Types of secondary batteries widely used today include lithium-ion batteries, lithium polymer batteries, nickel cadmium batteries, nickel metal hydride batteries, nickel zinc batteries, etc. The operating voltage of a unit secondary battery cells, i.e., a unit battery cell, is approximately 2.5 V to 4.6 V. Therefore, when a higher output voltage is required, a battery module may be configured by connecting a plurality of battery cells in series.

A general battery module may include a housing accommodating a plurality of battery cells and a top cover covering a top of the housing, and the housing may include a U-shaped frame having open top, front, and rear sides and a pair of end plates respectively covering the open front and rear sides of the U-shaped frame.

When a battery module experiences events such as side reactions of repeated charging and discharging, short circuits between battery cells, abnormal temperature increases, etc., a large amount of gas, heat, and pressure may be generated in the battery cells.

A large amount of gas, heat, and pressure generated from the battery cells may lift the top cover, causing damage to the battery module.

When a large amount of gas, heat, and pressure are not discharged smoothly, it may cause additional contamination inside the battery module, resulting in degradation of the performance and durability of the battery module.

### SUMMARY

According to an aspect of one or more embodiments of the present disclosure, in a battery module cover and a battery module including the same, a large amount of gas, heat, and pressure generated from a battery cell may be easily discharged to the outside to improve the performance and durability of the battery module, and a large amount of gas, heat, and pressure generated from the battery cell may be prevented or substantially prevented from being introduced to an adjacent battery cell.

However, aspects and problems to be solved according to embodiments of the present disclosure are not limited to the aspects and problems mentioned above, and other aspects and problems to be solved that are not mentioned can be understood through the following description and may be understood more clearly by the examples of the present disclosure. In addition, it will be appreciated that aspects, problems and advantages to be solved by the present disclosure may be realized by means and combinations thereof indicated in the claims.

According to one or more embodiments of the present disclosure, a battery module cover includes a cover body covering a plurality of battery cells accommodated in a battery module and including a plurality of venting portions exposing each battery vent of each of the plurality of battery cells and a blocking portion formed protrusively from each venting portion toward the corresponding battery vent.

In an embodiment, each venting portion may be formed in a shape of a hole penetrating the cover body.

In an embodiment, each venting portion may be formed to a size of at least 80% of a size of the battery vent.

In an embodiment, the blocking portion may be formed protrusively from an edge of each venting portion.

In an embodiment, the blocking portion may be bent from an edge of each venting portion toward the battery vent.

In an embodiment, a protruding end of the blocking portion may be in contact (e.g., close contact) with or adjacent to the edge of the battery vent.

In an embodiment, a distance between the protruding end of the blocking portion and the edge of the battery vent may be less than or equal to 1 mm.

In an embodiment, the cover body may include a material having heat resistance.

In an embodiment, the material may include mica.

In an embodiment, the battery module cover may further include a bus bar holder arranged between the plurality of battery cells and the cover body, in which the bus bar holder includes an opening overlapping a battery vent of each of the plurality of battery cells, and a protruding end of the blocking portion is in contact (e.g., close contact) with or adjacent to an edge of the opening of the bus bar holder.

According to one or more embodiments of the present disclosure, a battery module includes a plurality of battery cells, each including a battery vent and a battery module cover covering the plurality of battery cells, in which the battery module cover includes a cover body including a plurality of venting portions exposing each battery vent and a blocking portion protruding from each venting portion toward the corresponding battery vent.

In an embodiment, each of the venting portions may have a shape of a hole penetrating the cover body.

In an embodiment, each of the venting portions may have a size of at least 80% of a size of the battery vent.

In an embodiment, the blocking portion may protrude from an edge of each venting portion.

In an embodiment, the blocking portion may be bent from an edge of each of the venting portions toward the battery vent.

In an embodiment, a protruding end of the blocking portion may be in contact (e.g., close contact) with or adjacent to the edge of the battery vent.

In an embodiment, a distance between the protruding end of the blocking portion and the edge of the battery vent may be less than or equal to 1 mm.

In an embodiment, the cover body may include a material having heat resistance.

In an embodiment, the material may include mica.

In an embodiment, the battery module cover may further include a bus bar holder arranged between the plurality of battery cells and the cover body, in which the bus bar holder includes an opening overlapping a battery vent of each of the plurality of battery cells, and a protruding end of the blocking portion is in contact (e.g., close contact) with or adjacent to an edge of the opening of the bus bar holder.

### BRIEF DESCRIPTION OF THE DRAWINGS

The drawings included with this specification illustrate some embodiments of the present disclosure, and serve to further understand the technical idea of the present disclosure together with the detailed description of the present disclosure described later; however, the present disclosure is not to be construed as being limited to the matters shown in such drawings in which:

FIG. 1 is a perspective view showing a battery module according to an embodiment of the present disclosure;

FIG. 2 is an exploded perspective view of the battery module of FIG. 1;

FIG. 3 is a plan view of the battery module of FIG. 1;

FIG. 4 is a perspective view of a region “A” of FIG. 3;

FIG. 5 is a cross-sectional view of a portion taken along the line I-I′ of FIG. 4;

FIG. 6 is an enlarged cross-sectional view of a region “B” of FIG. 5; and

FIG. 7 is an enlarged cross-sectional view of a region “C” of FIG. 6.

### DETAILED DESCRIPTION

Herein, some embodiments of the present disclosure will be described in further detail with reference to the accompanying drawings. The terms and words used in the present specification and claims described above are not to be construed as being limited to ordinary or dictionary meanings, and should be interpreted as meanings and concepts consistent with the technical idea of the disclosure based on the principle that the present inventors may appropriately define the concept of the terms to describe their invention in the best way. Therefore, the embodiments described in this specification and the configurations illustrated in the drawings are some example embodiments of the present disclosure and do not necessarily represent all of the technical ideas of the present disclosure, and it is to be understood that there may be various equivalents and modified examples at the time of filing this application.

When used herein, “comprise,” “include,” and/or “comprising,” “including” may specify mentioned shapes, numbers, steps, operations, members, components, and/or presence of these groups, but do not exclude the presence or addition of one or more different shapes, numbers, operations, members, components, and/or groups.

To facilitate understanding of the present disclosure, the accompanying drawings may not be shown according to the actual scale, but the dimensions of some components may be exaggerated. The same reference numeral may be given to the same component in different embodiments.

A statement that two comparison components are “the same” as each other may mean that they are substantially the same as each other. Thus, a case in which the components are “substantially the same” as each other may include a case in which the components have a deviation regarded as a low level, e.g., a deviation of 5% or less. When a uniform parameter is uniform in a predetermined area, it may mean that it is uniform from an average point of view.

Although the terms “first,” “second,” etc., may be used to describe various components, these components are not limited by these terms. These terms are used to distinguish one component from other components, and unless specifically stated to the contrary, a first component may be a second component.

Throughout the specification, unless stated to the contrary, each component may be singular or plural.

When a component is arranged on “a top portion (or a bottom portion)” of another component or “on (or under)” the other component, it may mean not only a case in which the component is arranged adjacent to a top surface (or a bottom surface) of the other component, but also a case in which another component may be interposed between the other component and the component arranged on (or under) the other component.

When a component is described as being “connected,” “coupled,” or “connected” to another component, it is to be understood that the components may be directly connected or connectable to each other, but another component may be interposed between the components, or the components may be connected or coupled to each other through one or more other components. When a portion is electrically coupled to another portion, this may include not only a case in which they are directly connected to each other, but also a case in which they are connected with one or more other elements therebetween.

Throughout the specification, “A and/or B” may mean A, B, or A and B unless specially stated otherwise. That is, “and/or” may include all or any combination of a plurality of items listed. “C to D” may mean at least C but not more than D, unless specially stated otherwise.

The terminology used herein is for the purpose of describing embodiments of the present disclosure and is not intended to be limiting of the present disclosure.

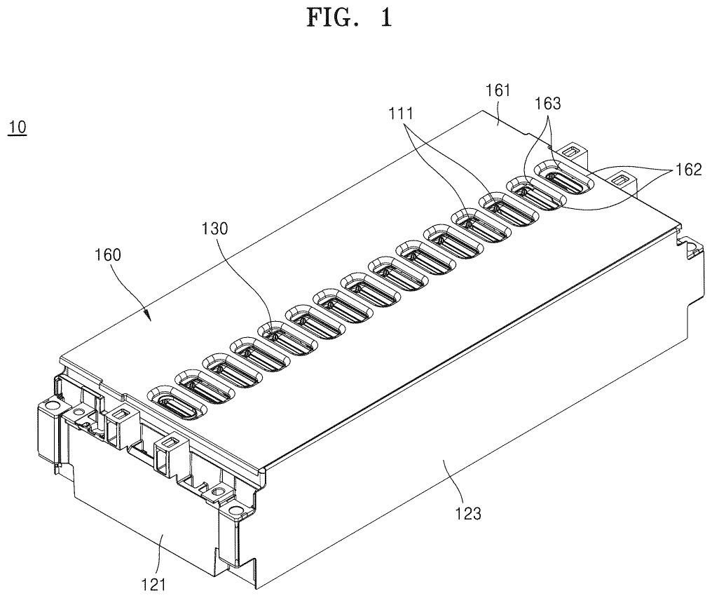

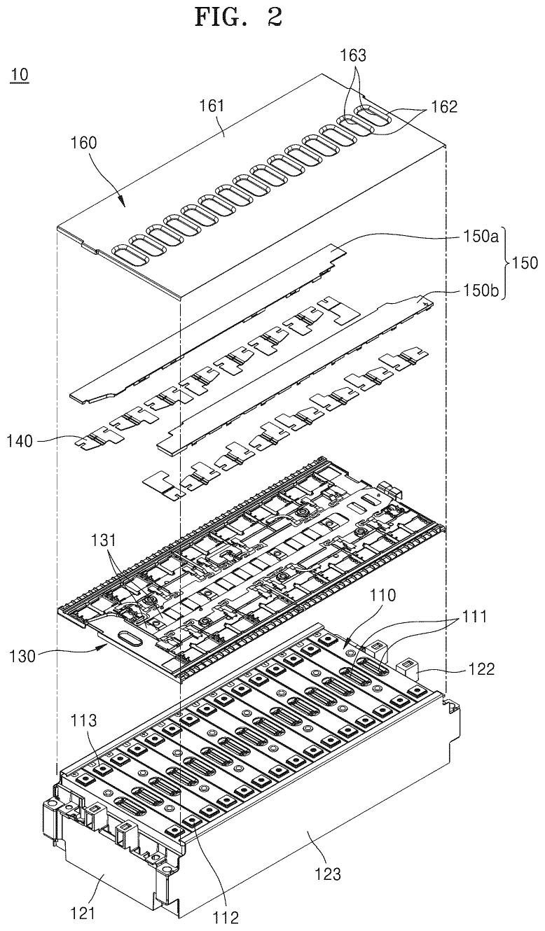

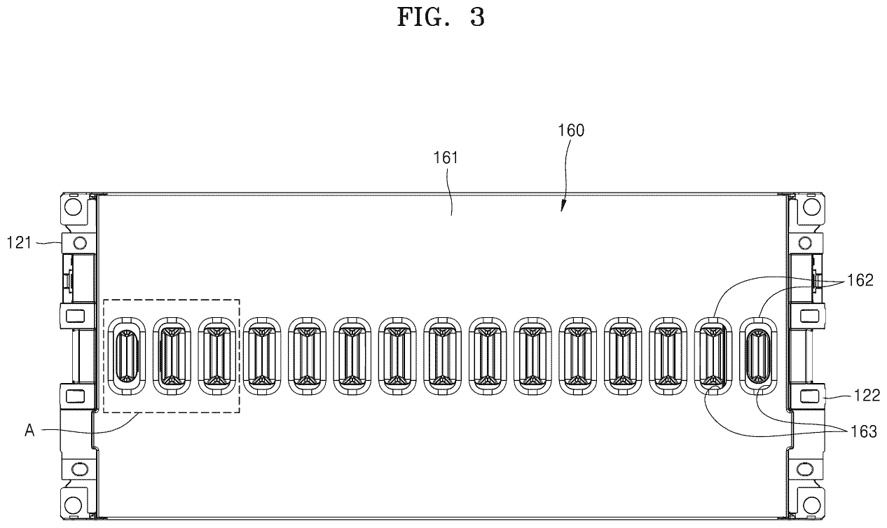

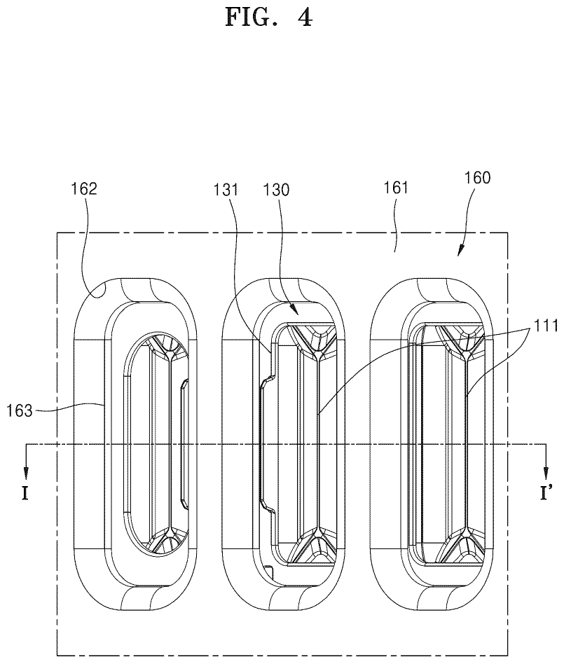

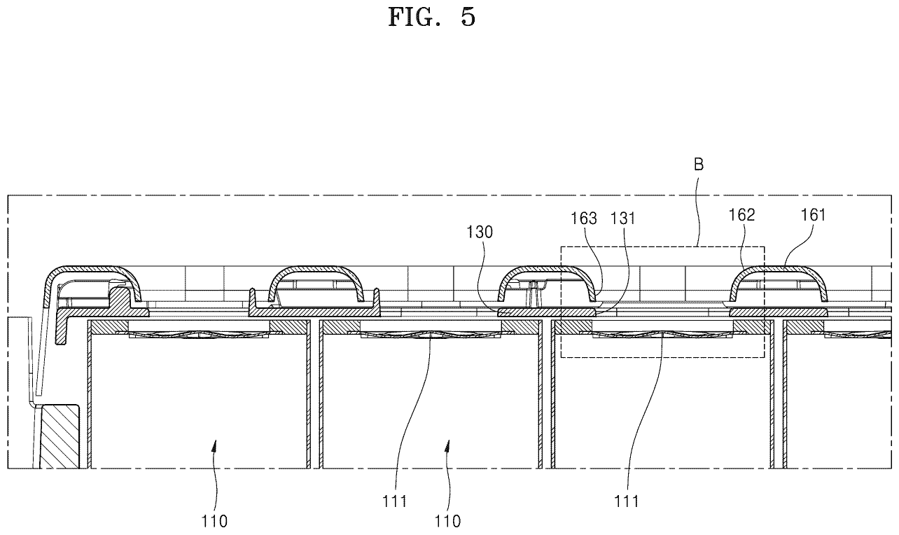

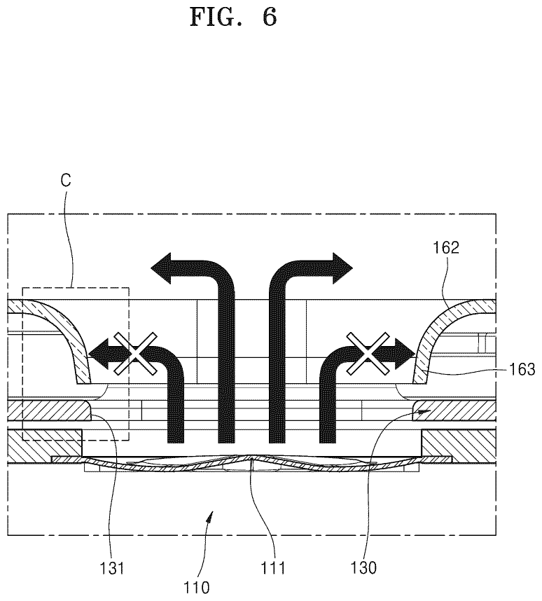

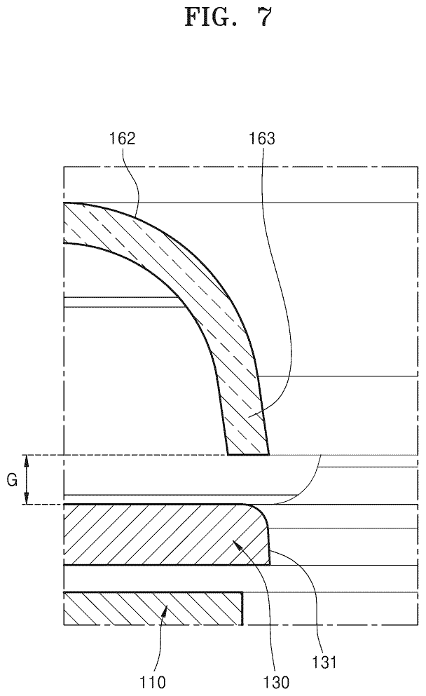

FIG. 1 is a perspective view showing a battery module according to an embodiment of the present disclosure. FIG. 2 is an exploded perspective view of the battery module of FIG. 1. FIG. 3 is a plan view of the battery module of FIG. 1. FIG. 4 is a perspective view of a region “A” of FIG. 3. FIG. 5 is a cross-sectional view of a region taken along the line I-I′ of FIG. 4. FIG. 6 is an enlarged cross-sectional view of a region “B” of FIG. 5. FIG. 7 is an enlarged cross-sectional view of a region “C” of FIG. 6.

Referring to FIGS. 1 and 2, a battery module 10 according to an embodiment of the present disclosure may be a battery assembly in which battery cells 110 are bundled in a certain number and accommodated in a frame to protect them from external shock, heat, vibration, etc.

A plurality of battery cells 110 included in the battery module 10 may be connected to each other in series or parallel, and each battery cell 110 may store electric energy and be discharged to supply the electric energy.

In an embodiment, a plurality of battery modules 10 may be bundled to form a single battery package, and as electric vehicles may require electric energy thousands of times greater than that of a smartphone, the battery modules 10 may be mounted in the form of a single battery package.

According to an embodiment, the battery module 10 may easily discharge a large amount of gas, heat, and pressure generated from each battery cell 110 to the outside, thereby improving the performance and durability of the battery module 10.

The battery module 10 according to an embodiment of the present disclosure may include a plurality of battery cells 110, a plurality of plates 121, 122, and 123, a bus bar holder 130, a bus bar 140, a bus bar cover 150, and a battery module cover 160.

Referring to FIGS. 1 and 2, the plurality of battery cells 110 according to an embodiment of the present disclosure may be stacked in a direction and may be surrounded by the plurality of plates 121, 122, and 123 and the battery module cover 160 to be protected from external impact, heat, vibration, etc.

However, a number and arrangement of the plurality of battery cells 110 are not limited to the structure illustrated in FIG. 2, and the number and arrangement may be changed as needed.

Each of the plurality of battery cells 110 according to an embodiment of the present disclosure may include a battery vent 111, a first terminal 112, and a second terminal 113.

The battery vent 111 according to an embodiment may correspond to a stabilizing device to discharge an excessive pressure and a gas that may be accumulated inside a secondary battery during a normal operation of the battery cell 110 or in an abnormal situation.

The battery vent 111 may be formed between the first terminal 112 and the second terminal 113 on a surface (e.g., a top surface in FIG. 2) of the battery cell 110, that is, in an approximately central region.

In an embodiment, the battery vent 111 may include a small opening or a one-way valve in the battery cell 110. That is, the battery vent 111 may prevent or substantially prevent an external gas from being introduced into the battery cell 110 while allowing an internal gas to escape from the battery cell 110.

Referring to FIG. 2, the first terminal 112 of an embodiment may be a positive terminal or a negative terminal.

If the first terminal 112 is a positive terminal, the second terminal 113 may be a negative terminal, and if the first terminal 112 is a negative terminal, the second terminal 113 may be a positive terminal.

That is, the first terminal 112 and the second terminal 113 may be formed with different electric polarities and are not limited to a specific polarity.

The first terminal 112 of the battery cell 110 may be electrically connected to the second terminal 113 of the adjacent battery cell 110 through the bus bar 140.

The second terminal 113 of the battery cell 110 may be electrically connected to the first terminal 112 of the adjacent or another battery cell 110 through another bus bar 140.

In an embodiment, the terminals 112 and 113 of the battery cell 110 are shown as being connected in series, but are not limited to such a structure, and various connection structures may be adopted.

Although not illustrated in detail, the battery cell 110 of an embodiment may include at least one electrode assembly (not shown) wound with a separator (not shown) as an insulator between a positive electrode (not shown) and a negative electrode (not shown), and a case (not shown) in which the electrode assembly is built or accommodated.

The battery cell 110 according to an embodiment of the present disclosure is illustrated as a lithium-ion battery cell having a prismatic shape, but is not limited thereto, and any of various types of battery cells, such as a lithium polymer battery cell or a cylindrical battery cell, may be used.

Referring to FIGS. 1 and 2, the plurality of battery cells 110 stacked in a direction may be accommodated by the housing.

In an embodiment, the housing may include, for example, the plurality of plates 121, 122, and 123.

In one or more embodiments, the plurality of plates 121, 122, and 123 according to an embodiment of the present disclosure may include a pair of end plates 121 and 122, a side plate 123, and a bottom plate (not shown).

The pair of end plates 121 and 122 may be respectively arranged at opposite end portions in a stacking direction of the plurality of battery cells 110 to fix and support the plurality of battery cells 110 in the stacking direction.

The side plate 123 may fix and support opposite side surfaces of the plurality of battery cells 110. That is, the side plate 123 may be arranged on each of the opposite side surfaces of the plurality of battery cells 110 stacked in a direction.

The bottom plate (not shown) may fix and support bottom surfaces of the plurality of battery cells 110. That is, the bottom plate may be arranged on the bottom surfaces of the plurality of battery cells 110 stacked in a direction.

In an embodiment, the side plate 123 and the bottom plate (not shown) are separated and coupled to each other, but the present disclosure is not limited thereto and the side plate 123 and the bottom plate may be formed in a single U-shaped unit.

The pair of end plates 121 and 122, the side plate 123, and the bottom plate (not shown) may be coupled by an engagement member, such as a bolt, etc., but the present disclosure is not limited thereto, and any suitable method for engagement, such as welding, etc., may be used.

Referring to FIGS. 2 and 5, the bus bar holder 130 according to an embodiment of the present disclosure may be positioned on the plurality of battery cells 110 and accommodate the bus bars 140.

Holes 131, which are openings overlapping battery vents 111 of the plurality of battery cells 110, may be formed in the bus bar holder 130.

That is, the plurality of battery cells 110 may discharge excessive pressure and gas through the corresponding battery vents 111 during normal operation or in an abnormal situation, and the pressure and gas discharged from the battery vents 111 may be discharged through the holes 131 of the bus bar holder 130 overlapping the battery vents 111.

Although not shown, the bus bar holder 130 may include a sensing unit (not shown) that performs various protective functions to improve the stability and lifespan of the battery module 10.

In an embodiment, for example, the sensing unit (not shown) may be connected to a battery management system (BMS) and electrically connected to the bus bars 140 through wires (not shown). That is, first ends of the wires may be respectively connected to the bus bars 140, second ends of the wires may be connected to the sensing unit, and the sensing unit may be connected to the BMS.

Referring to FIG. 2, the bus bar 140 according to an embodiment of the present disclosure may connect the plurality of battery cells 110, and a lead, which is an external conductor of each battery cell 110, may be connected to the bus bar 140 and welded.

As the leads are connected through the bus bar 140, it may be easy to identify the voltage of the plurality of battery cells 110 accommodated in the battery module 10 and stably manufacture the structure of the battery module 10.

Each of the bus bars 140 may have attached thereto a terminal for temperature measurement and/or a terminal for voltage measurement, and the measured information may be transmitted to the sensing unit (not shown) through the wire (not shown) and managed in an integrated manner.

Referring to FIG. 2, the bus bar cover 150 according to an embodiment of the present disclosure may be positioned on the bus bar holder 130 and may be coupled to the bus bar holder 130 to cover bus bars 140.

The bus bar cover 150 and the bus bar holder 130 may be coupled, for example, by a hook, but the present disclosure is not limited thereto, and any of various coupling methods, such as a screw engagement method, may be used.

In an embodiment, the bus bar cover 150 may protect the bus bars 140 from mechanical impact by integrally covering the bus bars 140 spaced apart from each other and prevent the bus bars 140 from being short circuited, thereby improving the stability of the battery module 10.

For example, if the battery module 10 experiences thermal runaway in an abnormal situation, a foreign substance may occur inside the battery module 10. For example, the foreign substance may be a fragment of the destroyed battery cell 110, and the fragment may be a conductive material included in the battery cell 110.

The bus bar cover 150 may cover the bus bars 140 to prevent or substantially prevent the bus bars 140 from contacting the fragments, thereby preventing the bus bars 140 from being short circuited and from causing additional secondary thermal runaway.

The bus bar cover 150 may include a plurality of covers 150a and 150b spaced apart from each other. The holes 131 of the bus bar holder 130 may be exposed between the plurality of covers 150a and 150b spaced apart from each other.

When the plurality of bus bar covers 150a and 150b expose the holes 131 of the bus bar holder 130, the temperature of the plurality of battery cells 110 increases, thereby forming a discharge path through which high-temperature gas and heat are discharged through the battery vent 111 and thus improving the stability of the battery module 10.

In an embodiment, the bus bar cover 150 may include the plurality of bus bar covers 150a and 150b, but the present disclosure is not limited thereto, and various changes may be possible, such as the bus bar cover 150 being configured as a single integral member having an opening exposing the holes 131 of the bus bar holder 130.

Referring to FIGS. 1 to 4, a battery module cover 160 according to an embodiment of the present disclosure may include a cover body 161 having a plurality of venting portions 162 and a blocking portion 163.

The cover body 161 according to an embodiment may cover exposed surfaces, i.e., top surfaces, of the plurality of battery cells 110 accommodated in the battery module 10.

In one or more embodiments, the cover body 161 may cover all of the bus bar holder 130, the bus bar 140, and the bus bar cover 150 arranged on the top surfaces of the plurality of battery cells 110 together with the plurality of battery cells 110.

The side and bottom surfaces of the exposed surfaces of the plurality of battery cells 110 stacked in a direction may be covered by a pair of end plates 121 and 122, the side plate 123, and the bottom plate (not shown), and other exposed surfaces, i.e., top surfaces, may be covered with the cover body 161.

The cover body 161 may be coupled to the side plate 123 by welding, but the present disclosure is not limited thereto, and may be coupled by an engagement method other than welding or by a composite method including welding.

The cover body 161 may be manufactured including a material having heat resistance. For example, a heat-resistant material may include, but is not limited to, mica, and may include other highly heat-resistant materials.

As the cover body 161 according to an embodiment has heat resistance, the cover body 161 may easily respond to high temperature and high heat in the event of side effects of repeated charging and discharging of the battery module 10 or abnormal situations.

As the cover body 161 according to an embodiment includes mica having heat resistance, even when exposed to an external flame, the cover body 161 may prevent or minimize melting or damage due to heat, thereby improving the durability and performance of the battery module 10.

In an embodiment, the cover body 161 may be formed of a heat-resistant material, especially mica, but the present disclosure is not limited thereto, and the cover body 161 may be formed by being first formed of a rigid material and then being applied with a heat-resistant material on a surface thereof.

Referring to FIGS. 1 to 4, the plurality of venting portions 162 may be formed through the cover body 161 of an embodiment to expose each the battery vents 111 of the plurality of battery cells 110, and, thus, the plurality of venting portions 162 may be formed through the cover body 161 at positions that overlap the battery vents 111.

The plurality of venting portions 162 may be formed in the form of holes that expose the battery vents 111 of the plurality of battery cells 110 to the outside.

In an embodiment, each of the plurality of venting portions 162 may have a size and shape capable of covering each battery vent 111.

For example, the battery vent 111 of an embodiment may have a long cut in a vertical direction (a vertical direction of FIG. 4), and, thus, the plurality of venting portions 162 may be formed long in an oval shape in the vertical direction (the vertical direction of FIG. 4).

In an embodiment, each venting portion 162 may be formed to a size of at least 80% of the corresponding battery vent 111. In an embodiment, a cut that is a gap through which high temperature heat and pressure are discharged occupies 80% of the total size of the battery vent 111.

Thus, each venting portion 162 of an embodiment may be formed to be at least 80% of the total size of the corresponding battery vent 111.

Referring to FIGS. 4 to 6, the blocking portion 163 of an embodiment may be formed to protrude from each venting portion 162 toward the corresponding battery vent 111.

The blocking portion 163 may be formed to protrude integrally from each venting portion 162 in an embodiment, but the present disclosure is not limited thereto, and may be manufactured as a separate member and provided, for example, by being adhered or welded to each venting portion 162.

Thus, the blocking portion 163 according to an embodiment may guide an exhaust discharged through the battery vent 111 corresponding to each venting portion 162, i.e., high-temperature gas, heat, and pressure to be discharged to outside through each venting portion 162 without being introduced to the adjacent battery vent 111.

In one or more embodiments, the exhaust discharged through each battery vent 111 may be discharged through the bus bar holder 130 and discharged to the outside through each venting portion 162, and the exhaust discharged through each battery vent 111 may be discharged through each venting portion 162 and move to the adjacent battery vent 111.

However, as the battery module cover 160 according to an embodiment of the present disclosure includes the blocking portion 163 protrusively formed on each venting portion 162, if the exhaust discharged through each battery vent 111 is about to enter the adjacent battery vent 111, the discharged product may fail to do so by being blocked by the blocking portion 163.

Thus, as the exhaust such as high-temperature gas, heat, and pressure, etc., discharged from each battery vent 111 may be discharged to the outside through the corresponding venting portion 162, additional contamination inside the battery module 10 due to the exhaust discharged from each battery vent 111 may be prevented or substantially prevented, thereby improving the durability and performance of the battery module 10.

Referring to FIGS. 5 to 7, the blocking portion 163 of an embodiment may be bent from an edge of the corresponding venting portion 162 toward the corresponding battery vent 111.

That is, the blocking portion 163 may be formed in a shape in which a flow cross-sectional area (corresponding to a horizontal width in FIG. 6) decreases from the edge of the corresponding venting portion 162 toward the corresponding battery vent 111.

As the flow cross-sectional area of the blocking portion 163 increases from a lower portion of the blocking portion 163 located on the battery vent 111 side to an upper portion located on the venting portion 162 side, the exhaust discharged through each battery vent 111 may be discharged to the outside more easily.

Even if the exhaust discharged through each battery vent 111 hits the blocking portion 163, the exhaust may be moved upward toward the corresponding venting portion 162, such that the exhaust hitting the blocking portion 163 may be more effectively prevented or substantially prevented from being introduced back to the battery vent 111.

A protruding end of the blocking portion 163 of an embodiment may be formed to be in close contact with or adjacent to the edge of the corresponding hole 131 of the bus bar holder 130, but the present disclosure is not limited thereto, and may be formed to be in close contact with or adjacent to the edge of the battery vent 111 when the bus bar holder 130 is already removed.

In an embodiment, a distance between the protruding end of the blocking portion 163 and the edge of the corresponding hole 131 of the bus bar holder 130, i.e., a gap G, may be formed to be 1 mm or less.

If an event such as thermal runaway occurs in an abnormal situation of the battery module 10, a foreign substance may be generated inside the battery module 10, and for example, the foreign substance may be a fragment of the destroyed battery cell 110 or a conductive material included in the battery cell 110.

In an embodiment, the gap G between the blocking portion 163 of an embodiment and the edge of the hole 131 of the bus bar holder 130 is formed to be greater than 1 mm, and the foreign substance such as the foregoing fragment may be introduced back into the adjacent battery vent 111 through the gap G, causing internal contamination and a short circuit between the battery cells 110.

In an embodiment, the gap G between the blocking portion 163 of an embodiment and the edge of the hole 131 of the bus bar holder 130 may be formed to be 1 mm or less.

Herein, a description will be made of a process in which high-temperature gas, heat, and pressure discharged from the battery vents 111 of the plurality of battery cells 110 may be discharged to outside through the battery module cover 160 according to an embodiment of the present disclosure.

Referring to FIGS. 5 to 7, in the battery module 10 according to an embodiment of the present disclosure, a large amount of high-temperature gas, heat, and pressure may be generated in the plurality of battery cells 110 if an event such as a side reaction of repeated charging and discharging or an abnormal temperature rise between the battery cells 110 occurs.

The exhaust such as a large amount of high-temperature gas, heat, and pressure, etc., may be discharged through the battery vent 111 of each battery cell 110 together with a foreign substance such as a fragment of the battery cell 110.

The foreign substance such as the exhaust, the fragment, etc., discharged from the battery vents 111 of the plurality of battery cells 110 may be discharged to outside through the venting portion 162 formed in the battery module cover 160 of an embodiment via the holes 131 of the bus bar holder 130.

The exhaust and foreign substance discharged from each battery vent 111 may be introduced into the adjacent battery vent 111 while being discharged to outside through each venting portion 162, causing internal contamination or a short-circuit between the battery cells 110.

However, the battery module 10 according to an embodiment of the present disclosure may prevent or substantially prevent the exhaust and the foreign substance discharged from each battery vent 111 from being introduced into the adjacent battery vent 111 by forming the blocking portion 163 formed protrusively on each venting portion 162.

If the exhaust and the foreign substance discharged from the battery vents 111 of the plurality of battery cells 110 attempt to enter the adjacent battery vent 111, they may be blocked by the blocking portion 163 formed protrusively on each venting portion 162.

Thus, the exhaust and the foreign substance discharged from each battery vent 111 may be discharged to outside through the corresponding venting portion 162, and may be prevented from entering the adjacent battery vent 111 through the blocking portion 163.

The battery module 10 according to one or more embodiments of the present disclosure may easily discharge the exhaust and the foreign substance discharged from the battery vents 111 of the plurality of battery cells 110 to the outside through the venting portion 162 formed in the battery module cover 160.

Thus, the stable fixing state of the battery module cover 160 of an embodiment may be maintained, thereby improving the durability and stability of the battery module 10 from an external impact, heat, and vibration.

The battery module 10 according to one or more embodiments of the present disclosure may prevent or substantially prevent exhaust and a foreign substance discharged from the battery vents 111 of the plurality of battery cells 110 from entering the adjacent battery vent 111 through the blocking portion 163 formed in the battery module cover 160.

Thus, internal contamination of the battery module 10 of an embodiment and a short circuit due to a fragment, such as a conductive material between the battery cells 110, may be prevented or substantially prevented, thereby improving the durability and performance of the battery module 10.

According to one or more embodiments, it is possible to easily discharge a large amount of gas, heat, and pressure generated from a battery cell to the outside to improve the performance and durability of the battery module, and prevent or substantially prevent a large amount of gas, heat, and pressure generated from the battery cell from being introduced to an adjacent battery cell.

However, aspects and effects obtainable through the present disclosure are not limited to the aspects and effects described above, and other technical aspects and effects not mentioned will be clearly understood by those skilled in the art from the description of the invention described below.

While the present disclosure has been described with respect to some embodiments and drawings, the present disclosure is not limited thereby and various modifications and changes may be made by those of ordinary skill in the art within the technical spirit of the present disclosure and the equivalent range to the claims.

What is claimed is:

1. A battery module cover comprising:
a cover body to cover a plurality of battery cells accommodated in a battery module and comprising a plurality of venting portions exposing a battery vent of each of the plurality of battery cells; and
a blocking portion formed protrusively from each of the venting portions toward a corresponding battery vent of the battery vents.

2. The battery module cover as claimed in claim 1, wherein each of the venting portions is formed in a shape of a hole penetrating the cover body.

3. The battery module cover as claimed in claim 2, wherein each of the venting portions has a size of at least 80% of a size of the battery vent.

4. The battery module cover as claimed in claim 1, wherein the blocking portion protrudes from an edge of each of the venting portions.

5. The battery module cover as claimed in claim 4, wherein the blocking portion is bent from an edge of each of the venting portions toward the battery vent.

6. The battery module cover as claimed in claim 4, wherein a protruding end of the blocking portion is in contact with or adjacent to an edge of the battery vent.

7. The battery module cover as claimed in claim 6, wherein a distance between the protruding end of the blocking portion and the edge of the battery vent is less than or equal to 1 mm.

8. The battery module cover as claimed in claim 1, wherein the cover body comprises a material having heat resistance.

9. The battery module cover as claimed in claim 8, wherein the material comprises mica.

10. The battery module cover as claimed in claim 1, further comprising a bus bar holder arranged between the plurality of battery cells and the cover body,
wherein the bus bar holder comprises an opening overlapping a battery vent of each of the plurality of battery cells, and a protruding end of the blocking portion is in contact with or adjacent to an edge of the opening of the bus bar holder.

11. A battery module comprising:
a plurality of battery cells, each comprising a battery vent; and
a battery module cover covering the plurality of battery cells;
wherein the battery module cover comprises:
a cover body comprising a plurality of venting portions, each exposing a corresponding battery vent; and
a blocking portion protruding from each of the venting portions toward the corresponding battery vent.

12. The battery module as claimed in claim 11, wherein each of the venting portions has a shape of a hole penetrating the cover body.

13. The battery module as claimed in claim 12, wherein each of the venting portions has a size of at least 80% of a size of the battery vent.

14. The battery module as claimed in claim 11, wherein the blocking portion protrudes from an edge of each of the venting portions.

15. The battery module as claimed in claim 14, wherein the blocking portion is bent from an edge of each of the venting portions toward the battery vent.

16. The battery module as claimed in claim 14, wherein a protruding end of the blocking portion is in contact with or adjacent to the edge of the battery vent.

17. The battery module as claimed in claim 16, wherein a distance between the protruding end of the blocking portion and the edge of the battery vent is less than or equal to 1 mm.

18. The battery module as claimed in claim 11, wherein the cover body comprises a material having heat resistance.

19. The battery module as claimed in claim 18, wherein the material comprises mica.

20. The battery module as claimed in claim 11, further comprising a bus bar holder arranged between the plurality of battery cells and the cover body,
wherein the bus bar holder comprises an opening overlapping a battery vent of each of the plurality of battery cells, and a protruding end of the blocking portion is in contact with or adjacent to an edge of the opening of the bus bar holder.
